(19) United States
(12) Patent Application Publication
(10) Pub. No.: US 2012/0259470 A1
(43) Pub. Date: Oct. 11, 2012

(54) BUILDING TEMPERATURE CONTROL APPLIANCE RECIEVING REAL TIME WEATHER FORECAST DATA AND METHOD

(76) Inventors: Neil Nijhawan, Louisville, KY (US); Kush Nijhawan, Louisville, KY (US)

(21) Appl. No.: 13/180,548

(22) Filed: Jul. 12, 2011

Related U.S. Application Data
(60) Provisional application No. 61/472,139, filed on Apr. 5, 2011.

(51) Int. Cl. G05D 23/19

(52) U.S. Cl. 700/278; 700/276

(57) ABSTRACT

The invention is a web enabled building temperature control appliance that receives data from the national weather service or from any other suitable source. This data consists of current temperature and pressure as well as forecasted temperature fluctuations. The building temperature control appliance would have a constant request/response process by using a Simple Object Access Protocol (SOAP) to gain access to the National Digital Forecast Database or other such weather forecast database. The building temperature control appliance would not turn on if the forecasted weather was within a zone of comfort chosen by the users. The zone of comfort is the band of temperature within which a person feels comfortable. This band of temperature is usually between 66 and 74 degrees Fahrenheit. Rather than having the heat turn on in the morning to heat the home to a set temperature the building temperature control appliance would allow the sun and the ambient outside air heat the home. In areas where the nights are cold and days are hot the building temperature control appliance would not heat the home in the morning when the forecast was for temperature hotter than the zone of comfort. There are many similar scenarios where the building temperature control appliance would act differently than a commonly known thermostat based upon information about the forecasted weather.

This application claims the benefit of provisional application 61/472,139 filed Apr. 5, 2011.

### FIELD OF THE INVENTION

This invention relates to a building temperature control device for residential or commercial buildings, that receives current weather data and forecast weather data from a national weather database and uses that information to more efficiently control the temperature of a building.

### BACKGROUND OF THE INVENTION

Energy consumption in homes accounts for one third of the energy consumption in the United States. Also, the United States has been known for its disproportionately high consumption of the world's energy. This high energy consumption is partially the result of inefficient heating and cooling of homes. Residences are inefficient because of insufficient insulation, inefficient heat/cooling sources and because thermostats aren't programmable and turn on at times when they are not needed. These thermostats may turn on many times while the occupants are away needlessly heating or cooling the residence. These thermostats may turn on the heat just before sunrise when the suns thermal radiation and the ambient outside temperature would heat the home naturally. Also, the thermostat may turn on the air conditioner just before sunset when the home would cool naturally from the outside temperature or from radiating heat to the atmosphere.

### SUMMARY OF THE INVENTION

The invention is a web enabled building temperature control appliance that receives data from the national weather service or from any other suitable source. This data consists of current temperature and pressure as well as forecasted temperature fluctuations. The building temperature control appliance would have a constant request/response process by using a Simple Object Access Protocol (SOAP) to gain access to the National Digital Forecast Database or other such weather forecast database. The building temperature control appliance would not turn on if the forecasted weather was within a zone of comfort chosen by the users. The zone of comfort is the band of temperature within which a person feels comfortable. This band of temperature is usually between 66 and 74 degrees Fahrenheit. Rather than having the heat turn on in the morning to heat the home to a set temperature the building temperature control appliance would allow the sun and the ambient outside air heat the home. In areas where the nights are cold and days are hot the building temperature control appliance would not heat the home in the morning when the forecast was for temperature hotter than the zone of comfort. There are many similar scenarios where the building temperature control appliance would act differently than a commonly known thermostat based upon information about the forecasted weather.

### BRIEF DESCRIPTION OF THE DRAWINGS

FIG. 1: Diagram of the request/response protocol

FIG. 2: Diagram of how Thermostat uses weather forecast data when cooling.

FIG. 3: Diagram of how Thermostat uses weather forecast data when heating.

FIG. 4: Thermostat Calendar screen shot.

FIG. 5: Diagram of alternate thermostat utilizing a personal computer.

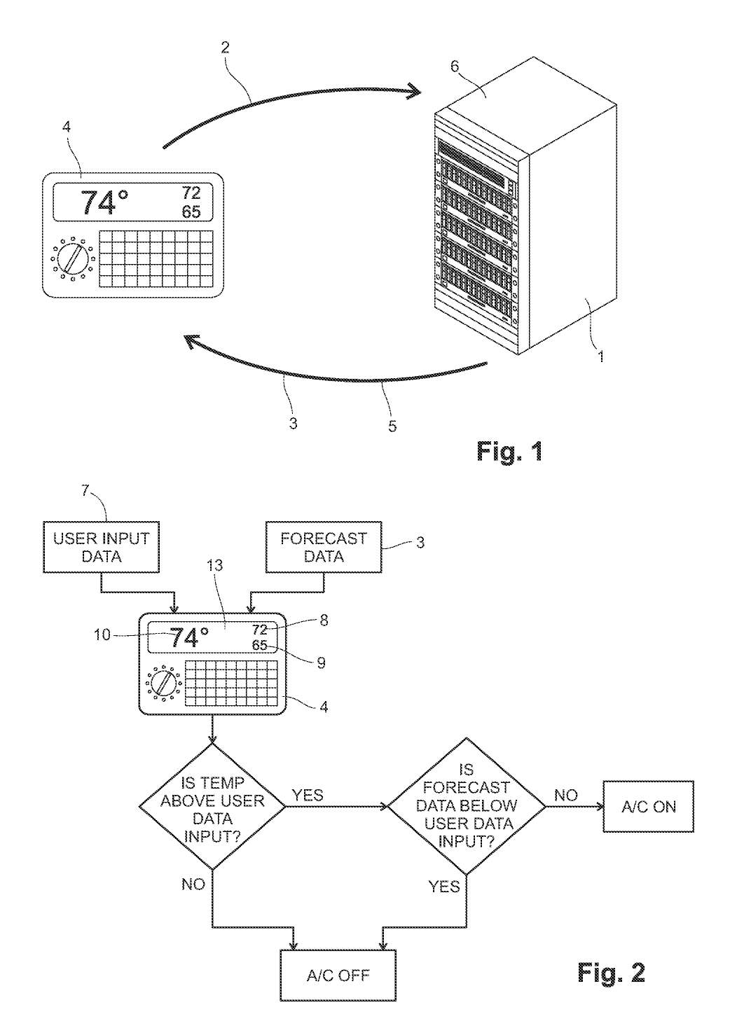

### DETAILED DESCRIPTION OF THE PREFERRED EMBODIMENT

The preferred embodiment of the invention is a web enabled building temperature control appliance 4 that adjusts its default settings based on forecast data 3 received from a weather forecast database 1. The preferred weather forecast database 1 is the National Digital Forecast Database (NDFD) 6. The Web enabled building temperature control appliance 4 sends Simple Object Access Protocol (SOAP) requests 2 preferably to the National Digital Forecast Database (NDFD) 6 or any other weather forecast database 1. The weather forecast database 1 then sends a SOAP response 5 which contains the forecast data 3. The web enabled building temperature control appliance 4 then uses this forecast data 3 to compare against the user input data 7 temperature and determines whether to operate the HVAC or not.

FIG. 2 shows example logic for determining whether the air conditioner will operate. The User input data 7 is the desired temperature range for the interior of a residence and is entered into the building temperature control appliance 4 directly by the user. The forecast data 3 is input periodically by the SOAP response 5 from the weather forecast database 1. The web enabled thermostat has a commonly used thermometer for measuring residential internal temperature 10. As the temperature changes or after a finite amount of time the web enabled building temperature control appliance 4, compares the current residential internal temperature 10 to the User data input 7. If the temperature is not above the upper temperature 8 input by the user then, the air conditioner stays off. If the residential internal temperature 10 is above the upper temperature 8 input by the user then, the forecast data 3 is compared to the upper temperature 8. If the Forecast Data 3 forecasts temperatures below the upper temperature 8 then the air conditioner stays off. If the Forecast Data 3 forecasts temperatures not below the upper temperature 8 then the air conditioner turns on.

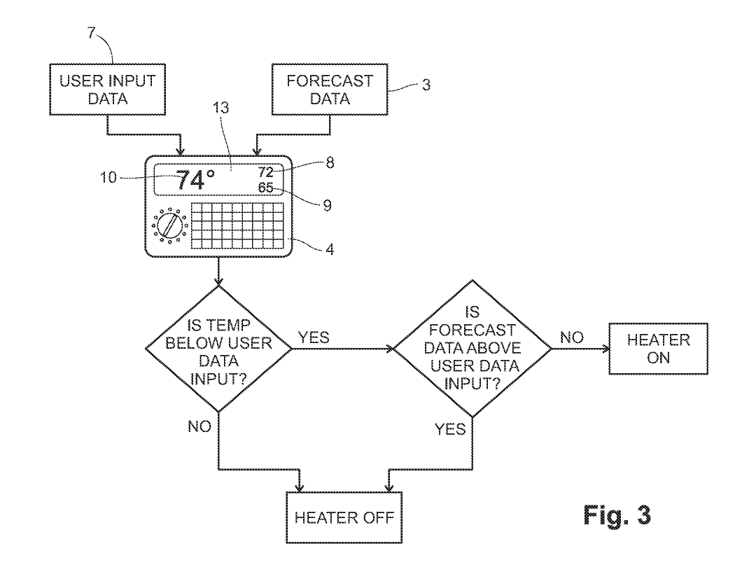

In FIG. 3 is an example of logic for determining if the heater will turn on. As the temperature changes or after a finite amount of time the web enabled building temperature control appliance 4, compares the current residential internal temperature 10 to the User data input 7. If the temperature is not below the lower temperature 9 input by the user then, the heater stays off. If the residential internal temperature 10 is below the lower temperature 9 input by the user then, the forecast data 3 is compared to the lower temperature 9. If the Forecast Data 3 forecasts temperatures above the lower temperature 9 then the heater stays off. If the Forecast Data 3 forecasts temperatures not above the lower temperature 9 then the heater turns on.

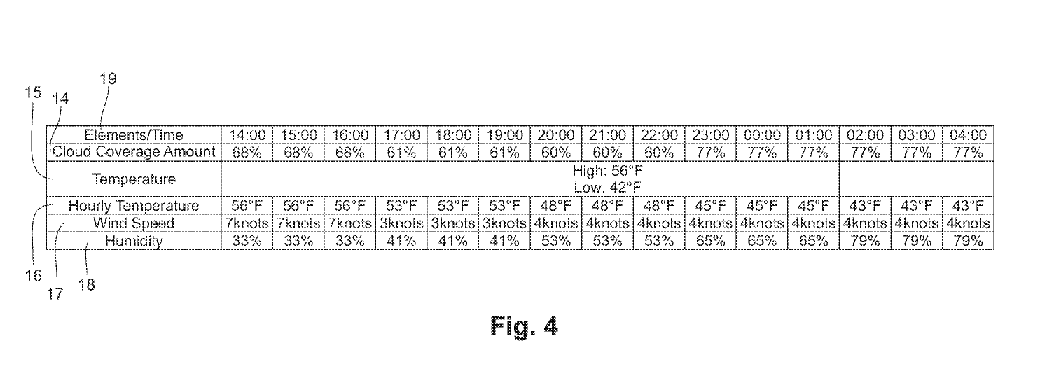

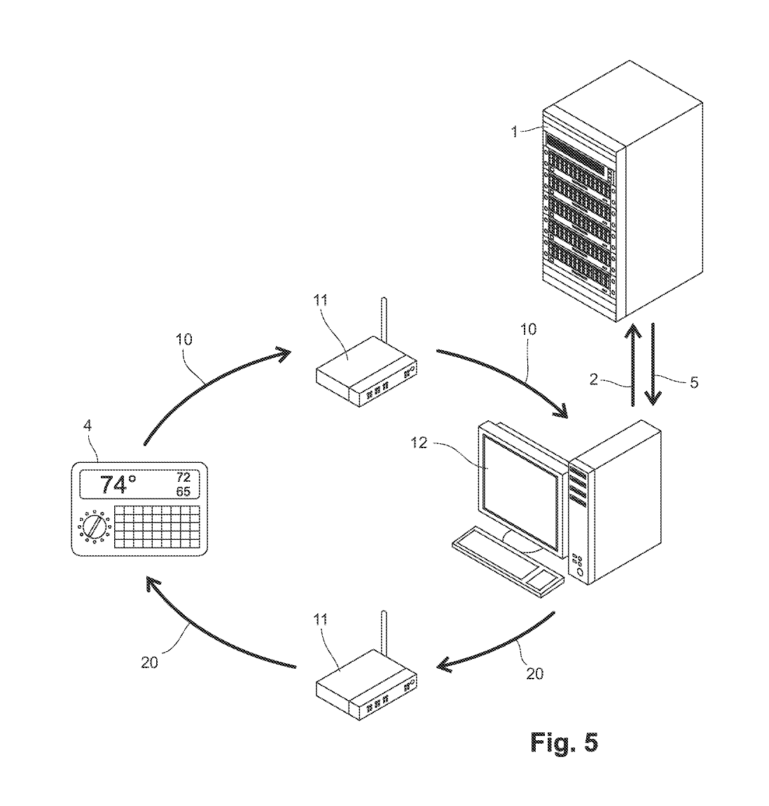

The preferred web enabled building temperature control appliance 4 will have a display 13 showing a daily calendar (FIG. 4). The daily calendar (FIG. 4) will have a row for cloud coverage amount 14, hourly temperature 16, wind speed 17, humidity 18 versus hours of the day 19. The daily calendar (FIG. 4) will also have a row for the forecasted high and low of the day 15.

The preferred web enabled building temperature control appliance 4 will use the forecasted humidity 18 to factor the forecasted temperature data 16 into an effective forecasted temperature based on humidity's effect on heat transfer to and from a residence. Cloud coverage percentage 14 will also factor into the effective forecasted temperature because of its effect on radiation heat transfer to and from a residence. The wind speed 17 is also used to create an effective forecasted temperature because of its effect on convection heat transfer to or from the residence. This effective forecasted temperature will then be compared to the user inputs 7,9 to determine if the heater or air conditioner should operate. The effective forecasted temperature is a more accurate prediction of the heat transfer to the residence or commercial building.

Another preferred embodiment of the web enabled thermostat 4 is a lower cost version that requires less computation ability. This web enabled thermostat 4 receives inputs of new interior temperature factors 20 to increase or decrease the upper temperature 8 or lower temperature 9 proportional to the amount of heating and cooling will take place from outside the residence. These interior temperature factors are received from a personal computer or other computing device 12 via wireless router 11. The personal computer 12 sends SOAP requests 2 to a weather forecast database 1 and receives forecast data 3. The personal computer or other computing device 12 uses the cloud coverage amount 14, the hourly temperature 16, the wind speed 17, and the humidity 18 to compute a heat transfer rate to the home. This heat transfer rate is then used to compute a factor that is applied to the upper and lower temperatures such that the thermostat will not turn on the heater when natural heating will occur or the air conditioner when natural cooling will occur.

Having described the invention, what is claimed is:

1. A building temperature control appliance comprising, an ability to control one or more pieces of heating or cooling equipment, a means for receiving and transmitting forecast data from a weather forecast database.

2. The building temperature control appliance of claim 1 further comprising a user interactive computer system having the ability to compute and compare data and execute commands to hardware.

3. The building temperature control appliance of claim 1 wherein the weather forecast database is the National Digital Forecast Database (NDFD).

4. The building temperature control appliance of claim 1 further comprising, a thermometer for measuring residential internal temperature.

5. The building temperature control appliance of claim 1 further comprising a user interface having, a display showing a daily calendar, the daily calendar having a row for forecasted cloud coverage amount, a row for forecasted hourly temperature, a row for forecasted wind speed, a row for hourly percent relative humidity, and a row for the forecasted high and low of the day.

6. The building temperature control appliance of claim 1 further comprising, a connection to the National Digital Forecast Database (NDFD), a commonly used thermometer for measuring residential internal temperature, a user interface having, a display showing a daily calendar, the daily calendar having a row for forecasted cloud coverage amount, a row for forecasted hourly temperature, a row for forecasted wind speed, a row for hourly percent relative humidity, and a row for a forecasted high and low for the day.

7. A method for conserving residential energy comprising the following steps, a building temperature control appliance with a means for receiving and sending information, requests weather forecast information from an online weather database, receives weather forecast data from the online weather database, compares weather forecast data against a user input and then prevents a heater or air conditioner from operating if a desired user input temperature will be reached through heat transfer.

8. The method of claim 7 where, the weather forecast information is requested using a Simple Object Access Protocol, and the weather forecast data is received using a Simple Object Access Protocol.

9. The method of claim 7 wherein, the building temperature control appliance predicts if forecasted weather conditions outside will cause the building to reach a desired internal temperature by heat loss or heat gain from the environment and then disallows the a heater or air conditioner to operate if the residence will reach a user's desired temperature.

10. The method of claim 7 wherein, if the residential internal temperature is not above a upper temperature input then, the air conditioner doesn't operate, but if the residential internal temperature is above the upper temperature input then, the forecast data is compared to the upper temperature and if the weather database forecasts temperatures below the upper temperature then the air conditioner does not operate but, if the data forecasts temperatures not below the upper temperature then, the air conditioner is allowed to operate.

11. The method of claim 7 wherein, if the residential internal temperature is not below a lower temperature input then, the heater does not operate but, if the residential internal temperature is below the lower temperature input then, the forecast data is compared to the lower temperature input and, if the weather database forecasts temperatures above the lower temperature then the heater does not operate but, if the weather database forecasts temperatures not above the lower temperature then, the heater is allowed to operate.

12. The method of claim 7 wherein, the forecast data is further manipulated, using a forecasted humidity to factor the forecasted temperature data into an effective forecasted temperature based on humidity's effect on heat transfer to and from a residence.

13. The method of claim 7 wherein, the forecast data is further manipulated, using a forecasted cloud coverage percentage to factor the effective forecasted temperature based on the cloud coverage's effect on radiation heat transfer to and from a residence.

14. The method of claim 7 wherein, the forecast data is further manipulated, using a forecasted wind speed to factor an effective forecasted temperature because of wind speed's effect on convection heat transfer to or from the residence.

15. The method of claim 7 wherein, the forecast data is further manipulated, using a forecasted humidity to factor the forecasted temperature data into an effective forecasted temperature based on humidity's effect on heat transfer to and from a residence and,
using a forecasted cloud coverage percentage to further factor the effective forecasted temperature based on the cloud coverage's effect on radiation heat transfer to and from a residence and,
using a forecasted wind speed to further factor an effective forecasted temperature because of wind speed's effect on convection heat transfer to or from the residence.

16. The method of claim 7 further comprising the following step, the building temperature control appliance with a means for receiving and sending information, receives barometric pressure data from an online weather database, and computes a computed weather forecast and compares the computed weather forecast against a user input and then prevents a heater or air conditioner from operating if a desired user input temperature will be reached through heat transfer.

17. A method for conserving residential energy comprising the following steps, a building temperature control appliance receives inputs of new interior temperature factors to increase or decrease the upper temperature or lower temperature set by the user inputs, proportional to the amount of heating and cooling that will take place from outside the residence, interior temperature factors are received from a personal computer by a means for sending digital data, the personal computer sends Simple object access protocol requests to a weather forecast database and receives forecast data, a computation device uses a cloud coverage amount, an hourly temperature, a wind speed, and a humidity to compute a heat transfer rate to a home, the heat transfer rate is then used to compute a factor that is applied to a user input upper temperature and a user input lower temperature, and these new factored upper temperatures and factored lower temperatures are sent to the building temperature control appliance and the building temperature control appliance will not operate a heater when natural heating will occur or operate an air conditioner when natural cooling will occur.

18. The method of claim 17 wherein, the temperature control appliance has no data processor and only receives new factored upper temperatures and factored lower temperatures by a means for receiving data.

19. The method of 17 wherein, the temperature control appliance can be installed or retrofit on a commonly known thermostat to save cost.
